(19) United States
(12) Patent Application Publication
(10) Pub. No.: US 2002/0010697 A1
(43) Pub. Date: Jan. 24, 2002

(54) On-line sports information entry and retrieval system

(76) Inventors: Robert S. Marshall, Ijamsville, MD (US); Christopher D. Sloop, Mount Airy, MD (US)

Correspondence Address: ROLAND H. SHUBERT, Post office Box 2339, Reston, VA, 20195-0339, US

(21) Appl. No.: 09/729,788

(22) Filed: Dec. 6, 2000

Related U.S. Application Data
(60) Provisional application No. 60/168,769, filed on Dec. 6, 1999.

(51) Int. Cl. G06F 17/30

(52) U.S. Cl. 707/10; 707/104.1

(57) ABSTRACT

An on-line sports information entry and retrieval system employs a dynamic database of local sports web pages linked to a media partner allowing the partner to feature community teams and athletes and to display game scores and statistics as they are reported. The database may be organized on a geographic or dominant market area basis so that teams and individual athletes may be ranked on a regional or national basis.

### BACKGROUND OF THE INVENTION

1. Technical Field

This invention relates to a system and program to compile a dynamic database of local sports information and to make that information available to users by way of broadcast media and the Internet.

More particularly, this invention relates to a method and means to provide sports leagues at all levels of amateur competition with dynamically managed web pages and associated databases that compile scores, individual and team statistics, provide and create schedules, handle administrative matters, and aggregate collected data above the team and league level to locale, district, regional, state and national levels.

2. Background Art

Traditionally, sports information has been disseminated through the broadcast and print media; newspapers, magazines, radio and television. Those media increasingly have tended to focus on the sports events of widest interest which usually are the games and competition of professional and semi-professional sports teams, teams of selected and well-known colleges and universities, and international competition such as the Olympic Games. At the same time, the number of students participating in high school athletics has been steadily increasing, reaching an all time high of approximately 6.5 million during the 1998-99 school year. An increasing interest in scores, individual and team statistics, team comparisons and team ratings has accompanied that increasing participation in amateur sports.

With the advent of the Internet, there have developed numerous web sites that feature information on both school sponsored and independent sports teams and leagues. Many local television stations and newspapers maintain a web site and feature local sports news on their web pages. Some web sites compile and display the scores of games and standings of teams within a particular league or geographic area while others are restricted to the happenings and prospects of a single team or school. Web sites have also developed which purport to assign a rank to teams within a sport that do not directly compete. Ranking is usually assigned by vote of coaches, sports writers, or by the public at large. Those rankings may be on a national basis, or may sometimes be restricted to teams within a certain defined area as within a single state or region of the country.

There are numerous companies that produce PC-based software for coaches and teams to compile and track team and individual statistics. Some of those programs allow the manual exporting of scores and other data of a statistical nature to web pages. Other specialty companies have evolved to supply the national media with sports information of a local nature but broader interest.

Despite all of those specialized information sources there lacks a consolidated network providing comprehensive coverage of amateur competitive sports and featuring dynamic local sports web pages displaying team, individual and league information, schedules, scores, standings, and statistics. This invention, which has come to be known as “InstaSports,” fills that need.

### SUMMARY OF THE INVENTION

This invention provides a consolidated network of dynamic local sports web pages that upon entry of data automatically update with the latest schedules, scores, standings, and statistics including aggregated individual, team, league, region and national statistics. The network provides a user-friendly, secure web interface for data entry and for carrying out team and league administrative functions. It provides links to local league and team information and allows automatic data distribution to local broadcast and print media.

### BRIEF DESCRIPTION OF THE DRAWING

Specific and preferred embodiments of this invention are illustrated and described with reference to the drawings, in which:

FIG. 1 illustrates a typical web page layout of the on-line sports information entry and retrieval system of this invention;

FIG. 2 is a diagram of a generic database layout of the system of FIG. 1;

FIG. 3 is a diagram of a typical scholastic sports organization in a particular state;

FIG. 4 depicts the general organization of a scholastic sports database;

FIG. 5 shows a typical web home page for the system of claim 1;

FIG. 6 illustrates a typical web page display of game scores and contest results available to a user of the system

FIG. 7 depicts a typical web page display of game statistics available to a user of the system;

FIG. 8 depicts the screen output of a display of team and player statistics available to a user of the system;

FIG. 9 illustrates a box score entry form that is accessible to a reporter or other authorized person;

FIG. 10 illustrates a program contained within the database and accessible to a team coach or other authorized person that may be used to create a team;

FIG. 11 depicts a team setup roster contained within the database and accessible to a team coach or other authorized person that shows the identity and positions of athletes on a particular team;

FIG. 12 depicts a team list that is accessible to a reporter or other authorized person; and

FIG. 13 illustrates a typical sports information display mode that may be used by a television broadcaster.

### DESCRIPTION OF PREFERRED EMBODIMENTS OF THE INVENTION

The information entry and retrieval system of this invention provides a comprehensive and revolutionary global computer network, or Internet, site to view local sports results from any location having access to that network. It provides viewers the latest available information on scholastic and league amateur sports, teams players, game schedules, team and player rankings, historical data, directions to game sites, and even current weather conditions at the location of any particular game. The site has organized, comprehensive menu options that allow convenient viewing of subject areas that are of interest and to select summary reports or to create custom reports on defined subject areas.

The site itself comprises a series of interrelated web pages, associated databases, and on-air graphics software that allow for sports league information, team and individual statistics, administrative matters, and related information of all kinds to be entered into the site pages and to be presented in dynamic fashion; that is, an automatic and immediate update of the web pages upon entry of each input of new data. The site is organized generally to include three regions or areas. A first of such areas may be considered to be a public area. It includes selected portions of integrated and aggregated data, such as game scores and statistics, that is made immediately accessible to users drawn from the general public. A second of such areas may be considered to be a private area. Access to this second area is restricted to persons authorized by the system administrator, and may include reporters, coaches, school and team officials and the like. The third area may be considered as a media area. Access to this third area is limited to selected media partners.

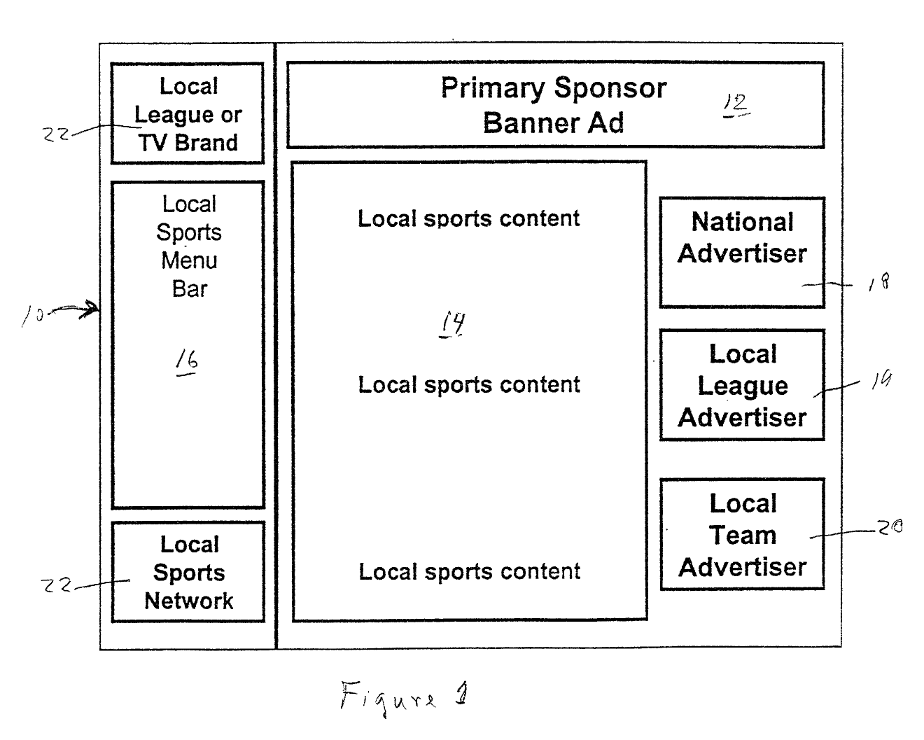

Referring now to the drawings, FIG. 1 illustrates at 10 the format of a typical web page that is accessible to a user at a designated web site. A banner ad 12 of a primary commercial sponsor of the web site is given prominent display, typically across the top of the page. A major portion 14 of the page holds the local sports content that has been accessed by a user through menu bar 16. That content may, for example, comprise the season record of a particular team, it may be a schedule for upcoming games, or it may be team or individual statistics, or other data and information contained within the system database. Space on the page may also be allocated for other national and local advertisers at other locations 18, 19 and 20. Also, space 22 on the page is ordinarily reserved to identify the local media outlet that is sponsoring the site in that particular local area. The format of the web page may be arranged and tailored to the needs of any local market.

An appropriate media partner may be selected from either the broadcast or print media. It is most advantageous that the media partners are television broadcasters as that medium provides the greatest flexibility for practice of this invention. However, a media partner may also be a radio broadcaster or a newspaper publisher. In a preferred embodiment, one media partner is selected for a designated market or circulation area, and the selected partner is granted exclusive rights to broadcast collected sports information in its designated market area.

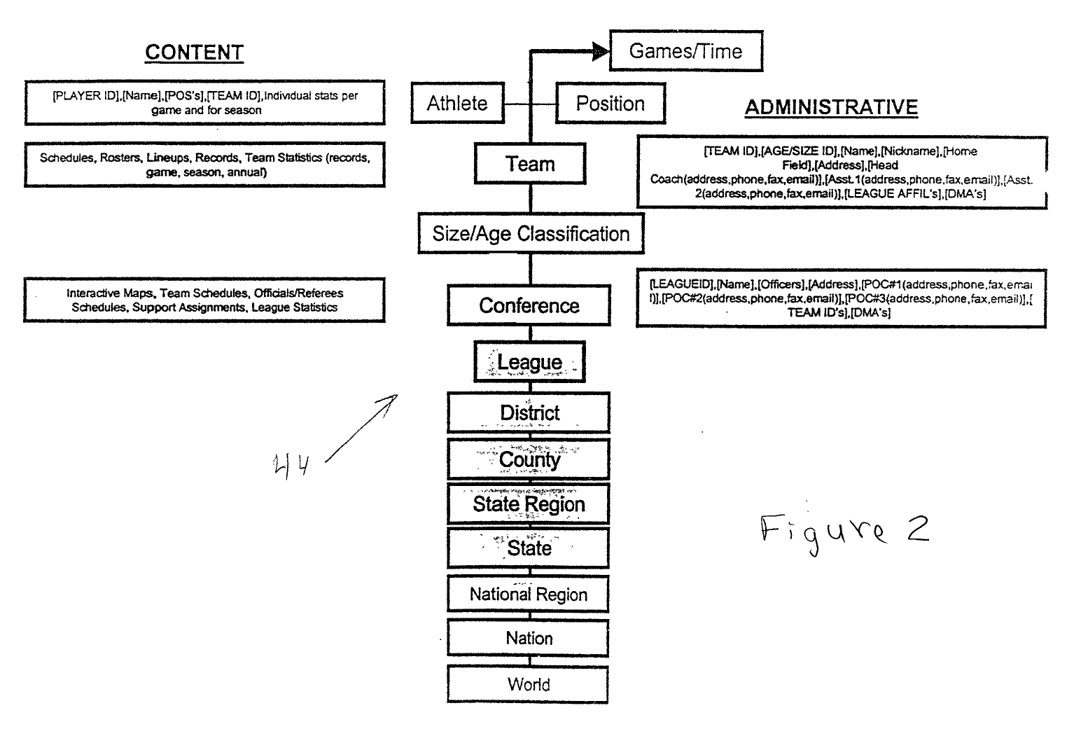

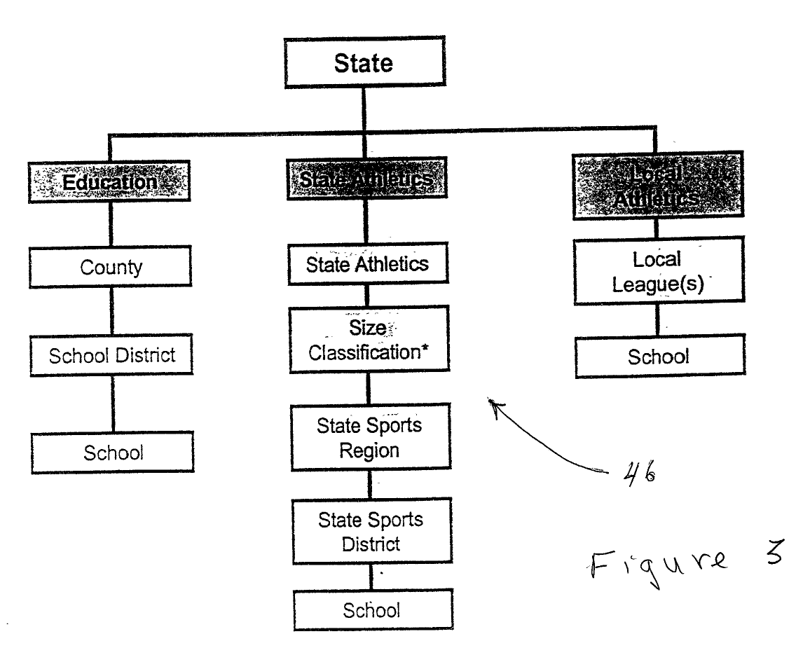

FIG. 2 depicts at 44 a generic arrangement or layout of the database of this invention while an exemplary organizational structure for a single state is illustrated at 46 in FIG. 3.

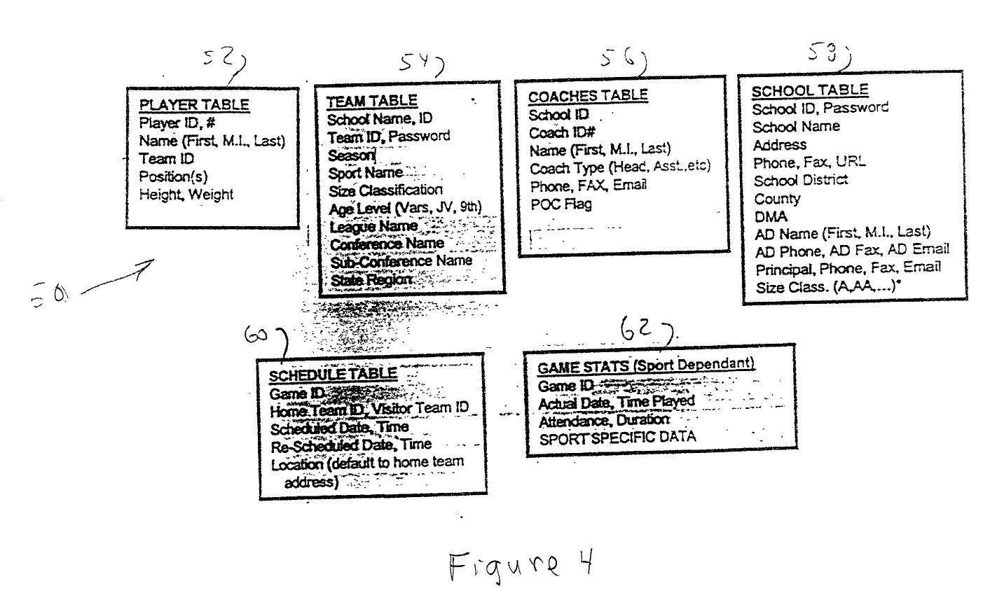

FIG. 4 presents in tabular form 50 the organization of a scholastic sports database. Groups making up that database include players 52, teams 54, coaches 56, schools 58, schedules 60 and game statistics 62.

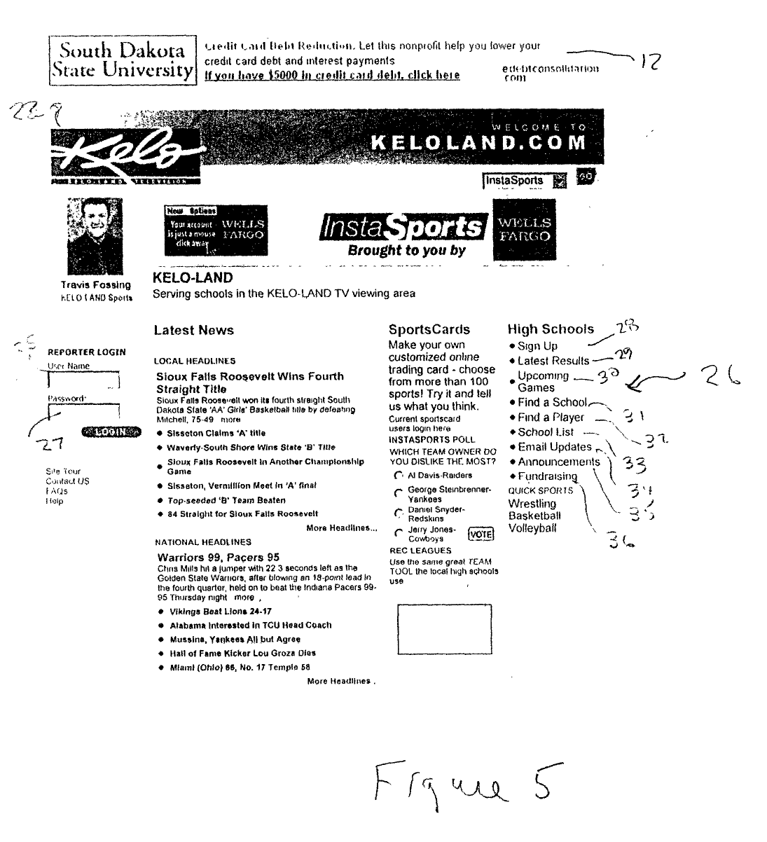

FIG. 5 is an illustration at 26 of a typical home page of the system of this invention. Persons accessing the web site would ordinarily view this web page first, and it serves as an entry point for both the public and private areas of the system. As was described in relation to FIG. 1, a banner ad 12 of a primary commercial sponsor runs across the top of the page. The media partner and sponsor is featured at the upper left at 22, while the local content portion 14 of the page includes in this instance a plurality of menu options 28, 29, 30, 31 32, 33, 34, 35, and 36. Each of those options allows entry into a more detailed page. Web site 26 is also an entry point for reporters to log into the system by entering a user name at location 25 and a password at location 27.

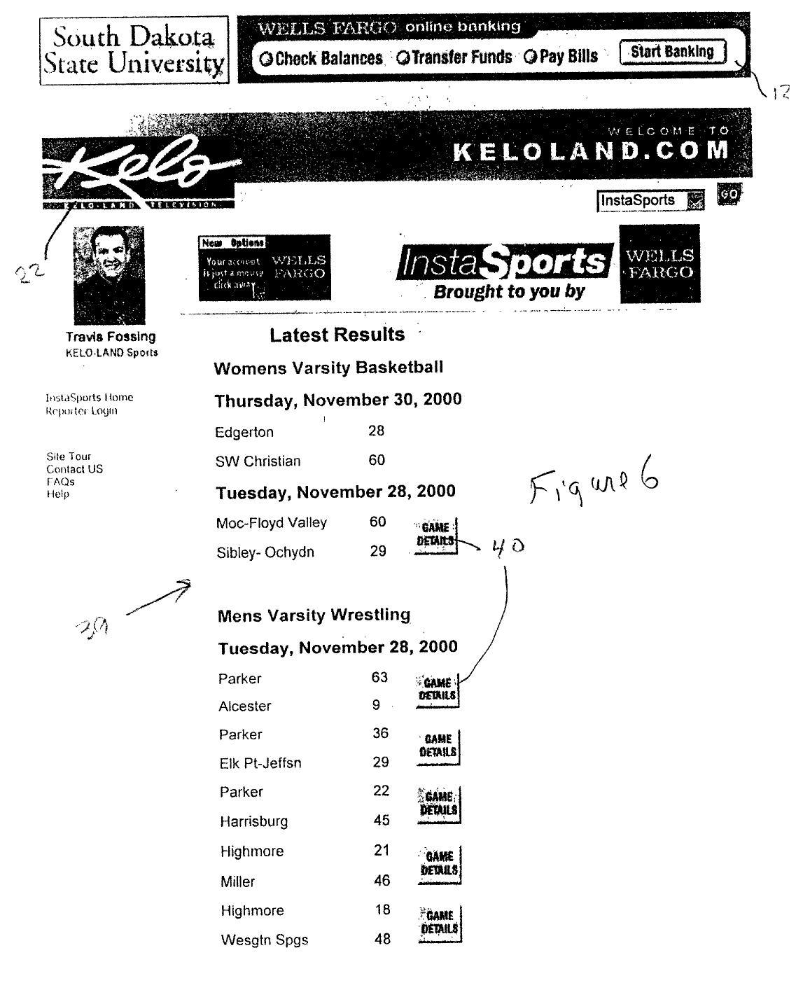

Users are drawn from the general public. A user may access a subject area selected from the FIG. 5 menu to access web pages such as those illustrated in FIGS. 6 through 8. A user, by clicking on option 29, “Latest Results,” for example, would call up a web page 39 such as that illustrated in FIG. 6. Again, this page features a top banner ad 12 and features the media sponsor at the upper left at 22. The local sports content section 14 of the page 39 then provides the latest results of sporting contests in the geographical area for which the media partner provides coverage; in this instance womens varsity basketball and mens varsity wrestling contests in the media partner's designated market area.

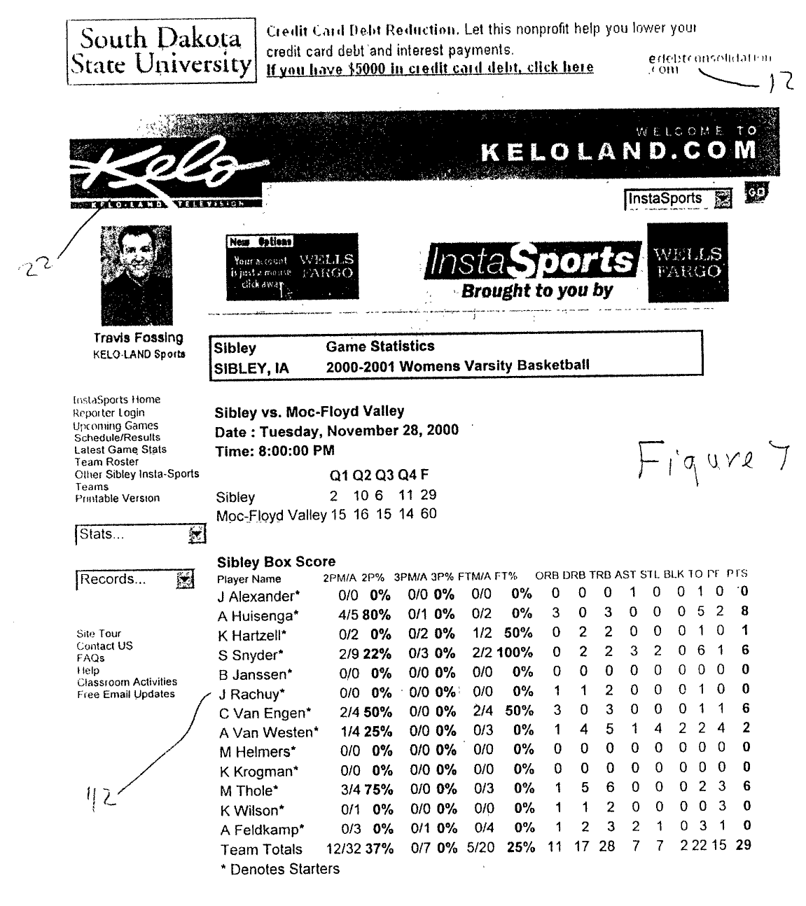

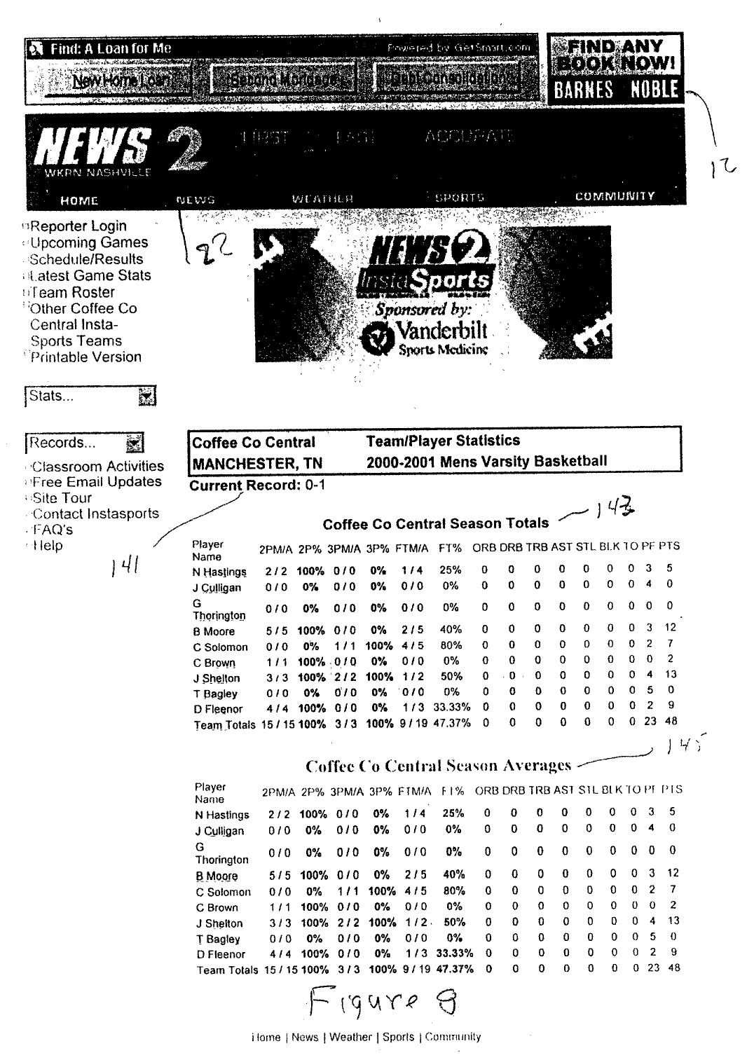

Game statistics compiled on each individual contest can be called up on yet another page, as is depicted at FIG. 7, by clicking on a “game details” icon 40 that accompanies each score tabulation. Statistics for one of the participating teams is shown in this instance, with each player's name listed at 42 together with data detailing each player's performance. Not only can detailed statistics for a single game be called up but team and player statistics for a season can be accessed as well as is illustrated in FIG. 8.

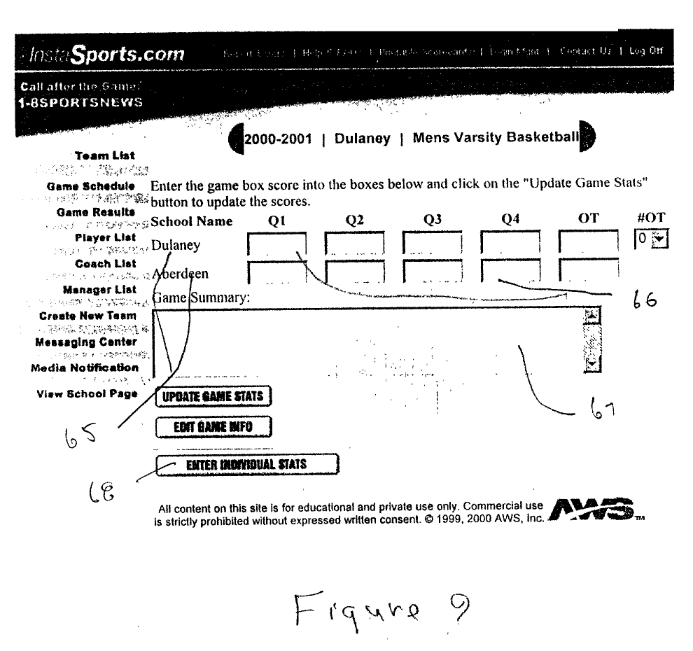

FIGS. 9 through 12 depict typical web pages from the second, or private, area of the database. As set out previously that portion of the database is available only to persons, such as reporters, who are authorized by the web administrator. A reporter may enter the system by providing his user name and password for the purpose of entering pertinent sports information as was referenced in the discussion of FIG. 5. A reporter may be a coach, a school administrator, a player or manager, or other person authorized to fulfill that function by his respective school and accepted by the system administrator.

Most of the information contained in the tables of the database requires input or confirmation from the reporters. The system of this invention is arranged to guide a reporter through each of the various tasks. A primary reporting task is to enter box scores of games and contests into the system database. FIG. 9 depicts a web page arranged for that purpose, in this instance for the box score entry of a basketball game by a reporter. As is illustrated in FIG. 9, the web page guides a reporter through the data and information needed. That information includes the names 65 of the schools fielding teams, the quarter-by-quarter game scores 66, and a narrative game summary 67. Individual player statistics may also be entered by clicking on the appropriate icon 68 which calls up a sub screen that is arranged to guide a reporter in the reporting process.

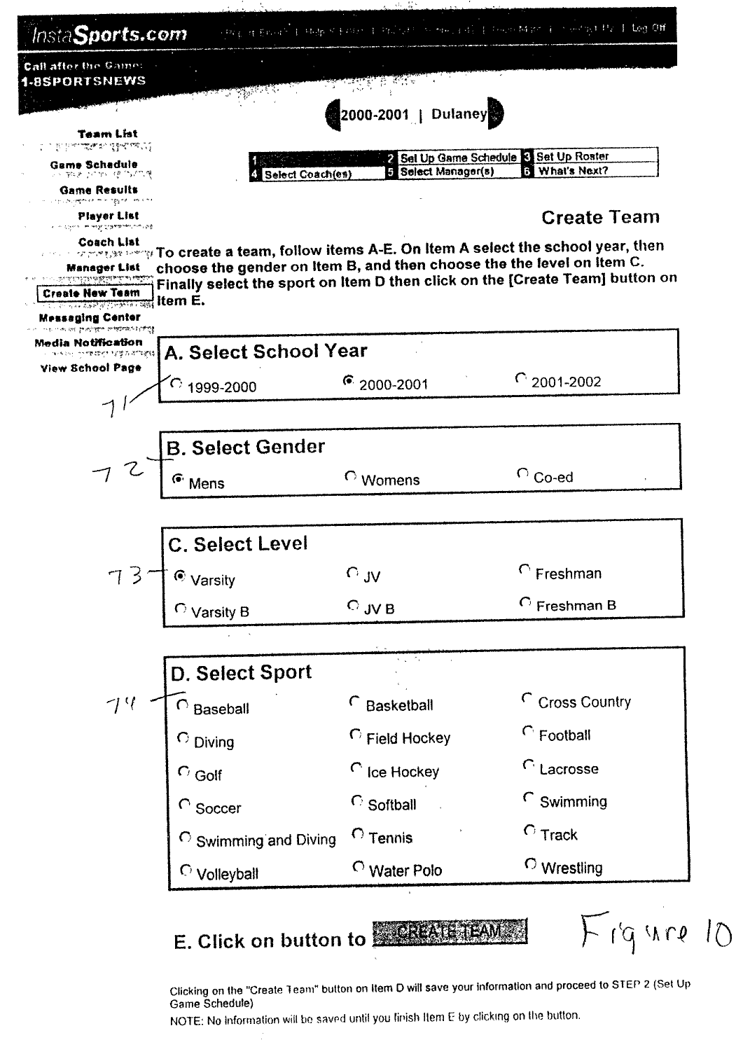

The database also contains a number of programs arranged to perform many of the administrative tasks encountered in setting up and operating an athletic program. One such task that is managed by a program contained in the database is that of creating a team. An illustrative task page for that purpose is depicted by FIG. 10. FIG. 10 guides the entry of data which defines a team including the school year 71, gender 72, level of play 73, and the sport for which the team is organized at 74.

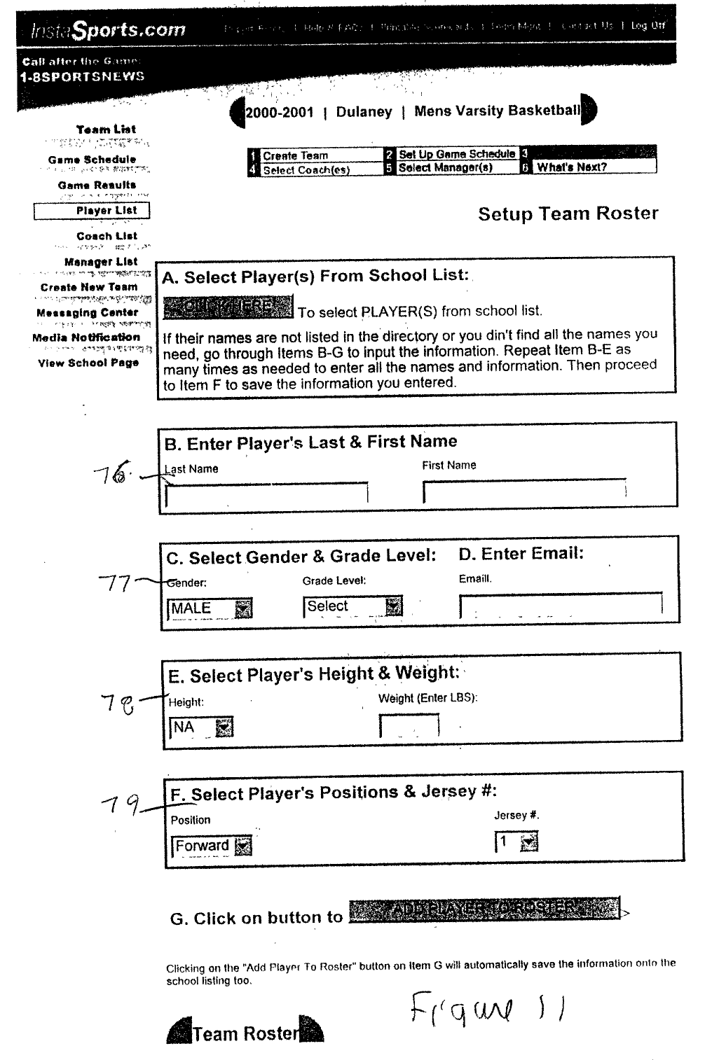

Another administrative task that is aided by means of an internal program within the database is that of setting up a team roster, and the task page illustrated in FIG. 11 guides that effort. Information concerning players selected for the team may be either drawn from a master list maintained by the school, or the entry of pertinent information about each team member is entered as called for by the task page. Information that is entered includes the player's name 76, the player's gender and grade level 77, the player's height and weight 78, and the player's position and uniform number at 79.

A similar program for setting up a game schedule is also contained in the database. Game schedules are designed by data entry through a site page (not shown) that is similar in concept to those site pages illustrated in FIGS. 10 and 11. Proposed game dates, times, locations, and opponents are entered at delineated locations on the page, and a schedule in chronological list form is then produced. The program is so designed as to prevent scheduling conflicts with other games or activities.

Another administrative task in any school athletic program is to create a list of all students within a school who are eligible for and desire to take part in the team athletic program of the school. The database also contains a program to create and maintain such a list. A master list of eligible students is prepared by reporters who ordinarily are either coaches or school administrators. The list contains basic identifying information about each student, including name, sex, height, weight, and grade level that are entered at delineated locations on yet another site page similar in concept and form to the team roster site page illustrated as FIG. 11. The student list so created can be sorted in a number of ways, by sex, by grade, alphabetically within each grade, etc. That master list is then used as a database from which the various teams are selected by means of a team roster setup menu such as that displayed in FIG. 11.

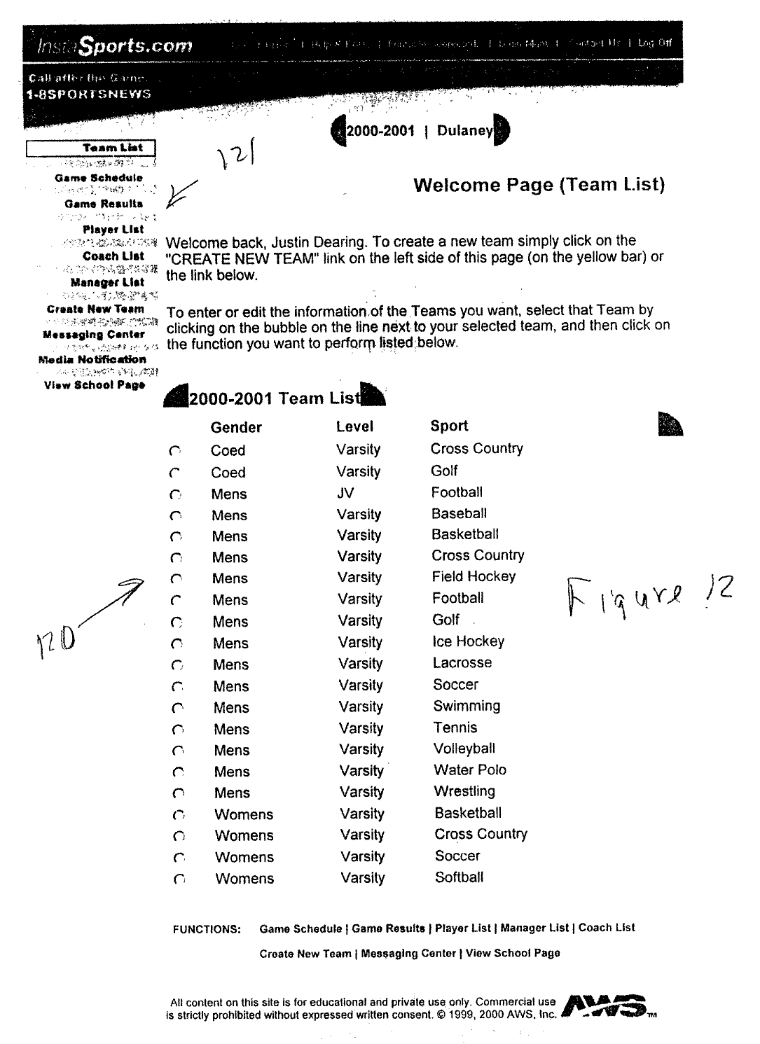

FIG. 12 shows a site page 120 that serves as a master list of all teams fielded or sponsored by a school or other organization. It also contains a general editing menu 121 that may be used by reporters and site administrators to edit or add to the sports database of FIG. 4. As shown by the menu selections at 121, changes to game schedules and the game results can be input here, as well as changes in players, coaches, and managers. Game results can be input here as well by reporters whose input is guided by a score entry form that is tailored to the particular sport such as the box score entry page illustrated by FIG. 9.

The dynamic database used in practicing this invention allows game scores to be immediately posted on the “Latest Results” web page of the media partner as new data are submitted by reporters. FIGS. 7 and 8 provide a example of the statistical detail and analysis that can routinely be provided to site visitors. All relevant statistics, such as the team record 141, season totals 143 and season averages 145, are automatically updated as well. In one preferred embodiment, the database is organized geographically, or by dominant market area, so that athletes and teams from different locations can be compared and ranked if desired.

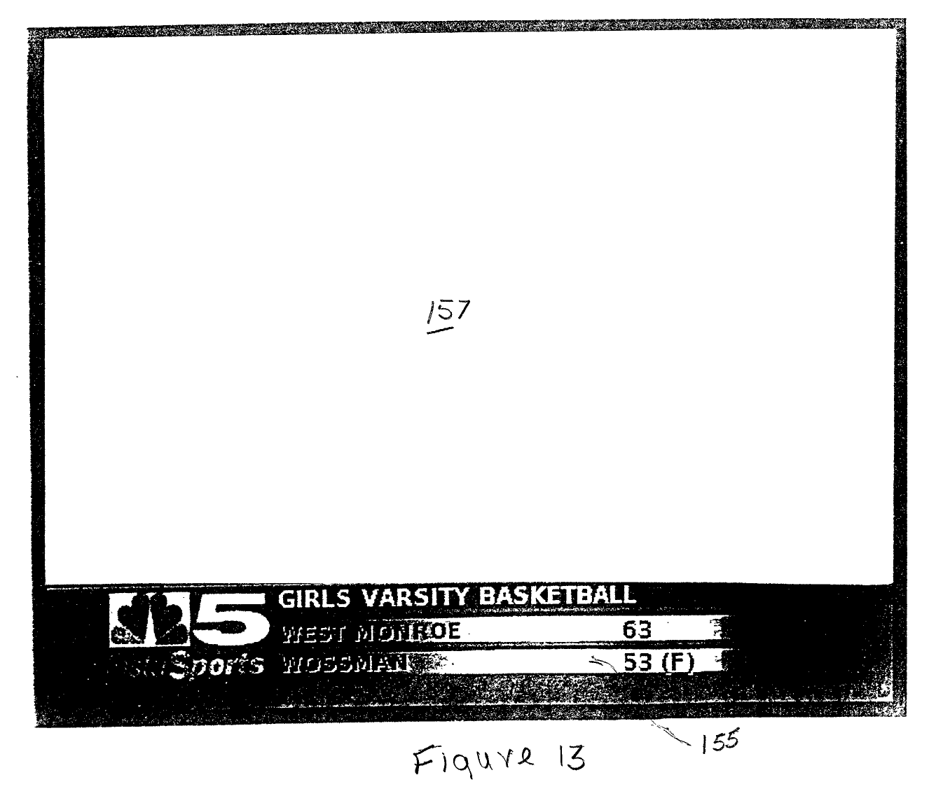

The game results are also automatically transmitted to the media partner for on-air, print, and web site use. If desired by a television media partner, those latest game results may also be displayed within a window on the television screen or as a ticker-like banner across the bottom of the screen. FIG. 13 is illustrative, and shows one of a number of presentation display modes that are available. In this instance, game scores are presented in ticker format 155 across the bottom of the screen while regular programming continues in the screen area 157 above the ticker. That allows a television broadcaster to feature community teams and athletes during broadcasts and so provide visibility never before obtained. Of course those same scores and information may be presented in full screen format as well.

It can now be appreciated that the sports information entry and retrieval system of this invention provides unsurpassed, timely coverage of local sports events and makes that information readily available from any location having Internet access.

1. A system for providing an on-line sports information collection and dissemination program comprising the steps of:
maintaining a database for accepting and storing sports information, scores and statistics;
designating reporters to gather sports information and to enter that information into said database through a global computer network web site;
defining a plurality of geographical regions;
providing a media partner for each of said geographical regions;
allowing said media partner to access geographically selected portions of that information contained in said database by way of said global computer network and to disseminate said selected information through its traditional medium;
presenting a user through said global computer network with a menu of information categories; and
allowing said user to access information contained in said menu categories without geographical limitation.

2. The system of claim 1 wherein said media partner is a television broadcaster.

3. The system of claim 2 wherein said geographical region is the designated market area of said broadcaster.

4. The system of claim 1 wherein said media partner is a radio broadcaster.

5. The system of claim 4 wherein said geographical region is the designated market area of said broadcaster.

6. The system of claim 1 wherein said media partner is a newspaper publisher.

7. The system of claim 6 wherein said geographical region is the circulation area of said newspaper.

8. The system of claim 1 wherein the sports information contained in said database includes the results of sporting contests within the designated market area of said media partner.

9. The system of claim 8 wherein said sporting contests include school and amateur league games and competitions.

10. The system of claim 1 wherein the information contained in said database includes team rosters, schedules, game statistics, individual player statistics and scores.

11. The system of claim 1 wherein said reporters are designated by his or her respective sports organization.

12. The system of claim 1 wherein said database includes a program arranged to prepare a game schedule for teams competing within a league.

13. The system of claim 1 wherein said database includes an editing program that allows reporters and other authorized personnel to record changes in schedules, rosters, and contest results.

14. The system of claim 1 wherein said database is organized geographically.

15. The system of claim 1 wherein said database includes means to compare and rank individual athletes and teams from different locations.

16. The system of claim 1 wherein the results of games and contests are transmitted to said media partner immediately upon entry into the database.
